(19) United States
(12) Patent Application Publication
(10) Pub. No.: US 2008/0308214 A1
(43) Pub. Date: Dec. 18, 2008

(54) Use of a Particular Composition for Producing Parts by Filament Winding

(75) Inventors: Laurent Gervat, Les Clayes Sous Bois (FR); Nicolas Passade-Boupat, Pau (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 11/916,098

(22) PCT Filed: May 31, 2006
(86) PCT No.: PCT/FR06/01233

§ 371 Date: May 29, 2008

(30) Foreign Application Priority Data
Jun. 1, 2005 (FR) 0505575

(51) Int. Cl. B29C 67/00

(52) U.S. Cl. 156/169

(57) ABSTRACT

The invention relates to the use of a composition for producing parts by filament winding, which comprises at least one type of resin formulation containing at least one type of thermosetting resin, at least one type of miscible rheology regulating agent which provides the composition with a viscosity difference whose factor is equal to or greater than 100 between a high-temperature state at a C₁ shear rate and a low temperature state at a C₂ shear rate, wherein the difference in temperature between the high-temperature and the low-temperature state is equal to or greater than 30° C., the C₁ shear rate is greater than the C₂ shear rate and the composition exhibits a Newtonian behavior in the high-temperature state thereof.

This application claims benefit, under U.S.C. §119 or §365 of French Application Number FR 05.05575, filed Jun. 1, 2005; and PCT/FR2006/001233 filed May 31, 2006.

### TECHNICAL FIELD

The present invention relates to the use of a composition comprising the combination of a thermosetting resin and a particular polymer for producing composite materials by filament winding.

The present invention also relates to a process for producing parts by filament winding from said composition.

The general field of the invention is therefore that of composite materials.

The composite materials result from the close combination of:
a reinforcement, which forms the armature or skeleton, ensuring the mechanical strength of the material, this reinforcement being of filament nature (mineral or organic fibers); and
a matrix, which links the reinforcing fibers, distributes the stresses (flexural or compressive strength) and provides chemical protection, while additionally giving the shape of the product produced, this matrix comprising an organic resin.

The two components (reinforcement and matrix) have qualities which combine together synergistically.

By varying the nature of the reinforcement and of the matrix, it is thus possible to attain materials having a very great diversity of mechanical and chemical properties.

This is the reason why composite materials find a very large number of applications in numerous fields, such as the aeronautics industry, the automotive industry, the naval industry and the construction industry.

### PRIOR ART

In order to produce composite parts, dozens of techniques are currently known, among which mention may be made, amongst others, of: contact molding, spray-up molding, lay-up molding, low-pressure molding, etc.

In a certain number of cases, especially when it is desired to obtain large hollow parts, it may be advantageous to work directly with wound fibers. These fibers may be used in prepreg form. However, these fibers are expensive and have a limited shelf life, considering the difficulty of keeping these fibers without curing of the resin occurring. This is why it may be advantageous, for producing hollow parts, to use the filament winding technique, which uses, at the outset, dry fibers.

More specifically, the filament winding technique consists in firstly making dry fibers pass into a bath comprising a resin then secondly in winding them onto a mandrel having a shape suitable for the part to be produced. The part thus obtained by winding is cured during a subsequent step, for example by heating.

The difficulty of this technique lies in the step of impregnating the dry fibers. This is because for a satisfactory impregnation, it is necessary that the composition be sufficiently liquid to correctly impregnate the fiber without however causing runs when the fiber exits the bath.

The compositions used to date do not make it possible to avoid this running phenomenon. This phenomenon is responsible for a sizeable loss of composition, inhomogeneous depositions at the surface of the fibers and soiling of the equipment.

There is therefore a real need for compositions that do not have the following drawbacks.

The inventors have surprisingly discovered that by incorporating, into a composition comprising a resin formulation, a polymer having particular rheological characteristics, it was possible to overcome the drawbacks of the compositions of the prior art used to produce parts by filament winding.

### SUMMARY OF THE INVENTION

Thus, the invention relates, according to a first subject, to the use of a composition for producing parts by filament winding, said composition comprising:
at least one resin formulation comprising at least one thermosetting resin;
at least one rheology control agent that is miscible in said formulation such that:
it gives the composition an at least 100-fold difference in viscosity between a high-temperature state at shear rate C₁ and a low-temperature state at shear rate C₂, the temperature difference between the high-temperature state and the low-temperature state being at least 30° C. and the shear rate C₁ being greater than the shear rate C₂; and
the composition has a Newtonian behavior at the high-temperature state.

It should be pointed out that, according to the invention, the shear rate C₁ results from the traveling speed of the fiber to be impregnated into the bath comprising the composition whereas the high-temperature state corresponds to the temperature in the bath, this temperature generally ranging from 40 to 150° C., for example from 80 to 100° C.

It should be pointed out that the shear rate C₂ results from the residual sliding of the composition deposited on the fiber, outside of the composition bath, this rate consequently being much lower than C₁, whereas the “low-temperature” state represents the temperature outside of the bath when the fiber is conveyed from the bath to the mandrel.

Due to a large difference in viscosity between the high-temperature state and the low-temperature state of the composition, the run phenomena on exiting the bath with fibers coated with this composition are significantly reduced, as is soiling on the various components of the process. The deposition thus remains uniform over the fibers. This results, after winding of the fibers onto a mandrel and curing, in a uniform distribution of the mechanical and physical properties of the resulting composite material.

Furthermore, due to the fact that the compositions of the invention have a Newtonian character in the “high-temperature” state, that is to say that their viscosity does not vary substantially with the strain rate of the mixture, it is possible to obtain fibers coated in an equivalent manner (that is to say, with an approximately identical amount of composition and a uniform distribution of the composition) regardless of the traveling speed of the fiber in the bath comprising the composition.

Finally, due to the fact that the abovementioned rheological characteristics (viscosity, Newtonian character) are mainly induced by the addition into the solution of the rheology control agent as defined above, this makes it possible to have greater freedom as to the choice of the resin formulation.

Advantageously, the rheology control agent induces a difference in viscosity between the high-temperature state and the low-temperature state of a factor of at least 500, and that does not generally exceed 10⁵, for example for a temperature difference between the high-temperature state and the low-temperature state of at least 60° C.

By way of example, the abovementioned compositions have a viscosity below 1 Pa·s at 100° C. (temperature of the bath of composition) and a viscosity of around 1000 Pa·s at ambient temperature (the ambient temperature corresponding to the temperature of the part onto which the filament winding process takes place).

The rheology control agents may be polymers, for example linear or branched polymers.

In particular, the rheology control agents may be block copolymers, of which at least one of the blocks is incompatible with said resin formulation.

According to one particular embodiment of the invention, the polymers conferring the compositions with the aforementioned rheological characteristics may be block copolymers comprising:
at least one M block miscible with said resin formulation; and
at least one B block incompatible with said resin formulation and said M block.

The M block is a polymer miscible with the resin formulation.

M may be a methyl methacrylate homopolymer.

M may also a methyl methacrylate copolymer.

For example, M may be a copolymer of methyl methacrylate and at least one water-soluble monomer.

This copolymer may comprise at least 20 wt % of methyl methacrylate, preferably at least 50 wt % of methyl methacrylate and a water-soluble monomer.

By way of example of water-soluble monomers, mention may be made of acrylic or methacrylic acid, amides derived from these acids such as for example dimethyl-acrylamide, 2-methoxyethyl(meth)acrylate, optionally quaternized 2-aminoethyl(meth)acrylates, polyethylene glycol (PEG) (meth)acrylates, water-soluble vinyl monomers such as N-vinylpyrrolidone or any other monomer that is soluble in water.

Advantageously, the polyethylene glycol group of the polyethylene glycol (meth)acrylates has a mass ranging from 400 g/mol to 10000 g/mol.

Preferably, the water-soluble monomer is dimethyl-acrylamide.

The molar proportion of methyl methacrylate may be from 10 to 95%, preferably from 60 to 90%, per 90 to 5%, preferably per 40 to 10%, of water-soluble monomer.

Moreover, the M block may comprise other monomers, such as reactive or unreactive acrylic or non-acrylic monomers. The expression “reactive monomer” is understood to mean a chemical group capable of reacting with the oxirane functional groups of the epoxy molecules or with the chemical groups of the curing agent.

By way of nonlimiting examples of reactive functional groups mention may be made of: oxirane functional groups, amine functional groups and carboxy functional groups. The reactive monomer may be (meth)acrylic acid or any other hydrolyzable monomer leading to these acids. Among the other monomers which may constitute the M block, mention may be made by way of nonlimiting examples of glycidyl methacrylate or tert-butyl methacrylate and n-butyl acrylate.

The B block is a polymer incompatible with the resin formulation and with the M block. Advantageously, the T_{g} of B is below 0° C. and preferably below −40° C. The monomer used to synthesize the B block may be a diene chosen from butadiene, isoprene, 2,3-dimethyl-1,3-butadiene, 1,3-pentadiene, 2-phenyl-1,3-butadiene. B is advantageously chosen from polydienes especially polybutadiene, polyisoprene and random copolymers thereof or else from partially or completely hydrogenated polydienes. Among the polybutadienes, those whose T_{g} is lowest, for example poly(1,4-butadiene) having a T_{g} (about −90° C.) below that of poly(1,2-butadiene) (about 0° C.), are advantageously used. The B blocks may also be hydrogenated. This hydrogenation is carried out according to standard techniques. The monomer used to synthesize the B block may also be an alkyl (meth)acrylate (in other words, the B block may be a poly(alkyl(meth)acrylate) such as ethyl acrylate (T_{g}=−24° C.), n-butyl acrylate (T_{g}=−45° C.), 2-ethylhexyl acrylate (T_{g}=−60° C.), n-octyl acrylate (T_{g}=−62° C.), hydroxyethyl acrylate (T_{g}=−15° C.) and 2-ethylhexyl methacrylate (T_{g}=−10° C.). Advantageously n-butyl acrylate is used. The acrylates are different than those of the M block in order to respect the condition of B and M being incompatible. Preferably, the B blocks are mainly composed of poly(1,4-butadiene). B is incompatible with the thermosetting resin and with the M block.

According to one particular embodiment, the rheology control agent is an M-B-M triblock copolymer, B and M being blocks such as defined above.

The two M blocks of the M-B-M triblock copolymer may be identical or different. When they are different, they may be different by the nature of the monomers constituting them or different by their molecular weight but composed of the same monomers.

The M-B-M triblock copolymer has a number-average molecular weight which may be between 10 000 g/mol and 500 000 g/mol, preferably between 20 000 and 200 000 g/mol. Advantageously, the M-B-M triblock has the following compositions of M and B, expressed as weight fractions, the total being 100%:

M: between 10% and 80%, preferably between 15 and 70%; and
B: between 90 and 20%, preferably between 85% and 30%.

One particularly suitable M-B-M triblock copolymer is a copolymer in which:
the M blocks represent a copolymer comprising the methyl methacrylate monomer and the dimethylacrylamide monomer; and
the B block is a homopolymer composed of the n-butyl acrylate monomer,
   the M blocks possibly also comprising the n-butyl acrylate monomer.

Another particularly suitable M-B-M triblock copolymer is a copolymer in which:
the M blocks represent a polymer comprising the methyl methacrylate monomer; and
the B block is a homopolymer composed of the n-butyl acrylate monomer,
   the M blocks possibly also comprising the n-butyl acrylate monomer.

The copolymers used as a rheology control agent may comprise, besides the B and M blocks, an S block incompatible with said resin formulation and the B block.

S is incompatible with the thermosetting resin and with the B block. The T_{g} or the Tₘ of S is advantageously above the T_{g} of B and above 23° C. and preferably above 50° C. By way of examples of S blocks, mention may be made of those which derive from vinylaromatic compounds such as styrene, α-methylstyrene, vinyltoluene, and those which derive from alkyl esters of acrylic and/or methacrylic acids having from 1 to 18 carbon atoms in the alkyl chain.

Preferably, the S block is a polystyrene.

According to one particular embodiment of the invention, the rheology control agent is an S-B-M triblock copolymer, S, B and M being blocks such as defined above.

The S-B-M triblock copolymer has a number-average molecular weight which may be between 10 000 g/mol and 500 000 g/mol, preferably between 20 000 and 200 000 g/mol. Advantageously, the S-B-M triblock copolymer has the following compositions of S, M and B, expressed as a weight fraction, the total being 100%:

M: between 10% and 80%, preferably between 15 and 70%;
B: between 2 and 80% and preferably between 5% and 70%; and
S: between 10 and 88% and preferably between 15 and 85%.

According to the invention, one part of S-B-M may be replaced by an S-B diblock. This part may represent up to 70 wt % of the copolymer.

One particularly suitable S-B-M triblock copolymer is a copolymer comprising:
an S block consisting of a homopolymer composed of the styrene monomer;
a B block consisting of a homopolymer composed of the 1,4-butadiene monomer; and
an M block consisting of a homopolymer composed of the methyl methacrylate monomer.

According to another embodiment of the invention, the polymers that can be used as a rheology control agent and that confer on the compositions containing them the aforementioned rheological characteristics, may be block copolymers comprising:
at least one B block incompatible with said resin formulation; and
at least one S block incompatible with said resin formulation and the B block.

The S and B blocks may be such as defined above.

In particular, these copolymers may be S-B diblock copolymers, in which:
the S block consists of a homopolymer composed of the styrene monomer; and
the B block consists of a homopolymer composed of the 1,4-butadiene monomer.

The compositions used according to the invention comprise a resin formulation consisting of at least one thermosetting resin.

Advantageous thermosetting resins are epoxy resins.

Epoxy resin, denoted hereinafter by E, is understood to mean any organic compound having at least two oxirane-type functional groups, polymerizable by ring opening. The term “epoxy resins” denotes all common epoxy resins that are liquid at ambient temperature (23° C.) or at a higher temperature. These epoxy resins may be monomeric or polymeric on the one hand, aliphatic, cycloaliphatic, heterocyclic or aromatic on the other hand. As examples of such epoxy resins, mention may be of resorcinol diglycidyl ether, bisphenol A diglycidyl ether, triglycidyl p-aminophenol, bromobisphenol F diglycidyl ether, m-aminophenol triglycidyl ether, tetraglycidyl methylene dianiline, (trihydroxy-phenyl)methane triglycidyl ether, phenol-formaldehyde novolac polyglycidyl ethers, ortho-cresol novolac polyglycidyl ethers and tetraphenylethane tetraglycidyl ethers. Mixtures of at least two of these resins may also be used.

Epoxy resins having at least 1.5 oxirane functional groups per molecule and more particularly epoxy resins containing between 2 and 4 oxirane functional groups per molecule are preferred. Epoxy resins having at least one aromatic ring, such as bisphenol A diglycidyl ethers, are also preferred.

The resin formulation generally comprises a curing agent.

Regarding the curing agent, mention may be made of:
acid anhydrides, among which mention may be made of succinic anhydride;
aromatic or aliphatic polyamines, among which mention may be made of diaminodiphenyl sulfone (DDS), methylenedianiline, 4,4′-methylenebis(3-chloro-2,6-diethylaniline) (MCDEA), 4,4′-methylenebis(2,6-diethyl-aniline) (MDEA);
dicyandiamide and its derivatives;
imidazoles;
polycarboxylic acids; and
polyphenols.

It would not be outside the scope of the invention to add some customary additives to the composition, for instance thermoplastics such as polyethersulfones, polysulfones, polyetherimides, polyphenylene ethers, liquid elastomers or core-shell impact modifiers.

The composition of the invention may be prepared by mixing the resin formulation and the rheology control agent by any conventional mixing technique. It is possible to use any thermoplastic technique that makes it possible to produce homogeneous mixing between the two parts of the thermosetting resin and the control agent, such as extrusion.

Regarding the proportion of the resin formulation and of the rheology control agent, the proportion of the agent advantageously ranges from 5 to 20 wt % per 95 to 80 wt % of the resin formulation. Preferably, the content of the agent advantageously ranges from 5 to 15 wt % per 95 to 85 wt % of the resin formulation.

As mentioned above, the compositions described are used for producing parts by filament winding.

Thus, the invention relates, according to a second subject, to a process for producing a part by filament winding that successively comprises:
a step of passing fibers intended to form the reinforcement of the part into a bath that consists of a composition that is composed of at least one resin formulation comprising a thermosetting resin;
a step of winding the fibers thus coated onto a mandrel of suitable shape;
a step of curing the wound fibers, characterized in that the composition comprises, in addition, at least one rheology control agent that is miscible in said formulation such that:
it gives the composition an at least 100-fold difference in viscosity between a high-temperature state at shear rate C₁ and a low-temperature state at shear rate C₂, the temperature difference between the high-temperature state and the low-temperature state being at least 30° C. and the shear rate C₁ being greater than the shear rate C₂; and
the composition has a Newtonian behavior at the high-temperature state.

The rheology control agent is such as defined above.

Thus, according to one particular embodiment of the invention, the rheology control agent may be a block copolymer comprising:
at least one M block miscible with said resin formulation; and
at least one B block incompatible with said resin formulation and said M block.

The M and B blocks are such as defined above.

According to another embodiment, the rheology control agent may be a block copolymer comprising:
at least one B block incompatible with said resin formulation; and
at least one S block incompatible with said resin formulation and the B block.

The B and S blocks are such as defined above.

The fibers intended to constitute the reinforcement of the part may be glass fibers, carbon fibers or else aramid fibers.

Firstly, these fibers are conveyed from an unwinding creel towards an impregnation bath, where they are coated with the composition described above.

Secondly, they are conveyed by a guiding system towards the aforementioned mandrel then deposited on it.

Once the deposition operation is finished, the coated fibers are subjected to a curing step which may take place:
at ambient temperature;
by heating, for example, in an oven; or
by induction via ultraviolet or infrared radiation.

The curing step will especially depend on the nature of the curing agent introduced into the composition.

The composition used according to the invention may be applied for manufacturing parts in a large number of fields. Thus, the invention relates to parts obtained by the aforementioned process, said parts possibly being intended for the aeronautics industry, the naval industry, the construction industry, the manufacture of wind turbines, the manufacture of pipes for the transport of fluids, for example in factories of the chemical industry or for the transport of hydrocarbons.

Finally, the invention relates to a composition for manufacturing parts by filament winding, the composition being such as defined above.

Thus, according to one particular embodiment of the invention, the rheology control agent may be a block copolymer comprising:
at least one M block miscible with said resin formulation; and
at least one B block incompatible with said resin formulation and said M block.

The M and B blocks are such as defined above.

According to another embodiment, the rheology control agent may be a block copolymer comprising:
at least one B block incompatible with said resin formulation; and
at least one S block incompatible with said resin formulation and the B block.

The B and S blocks are such as defined above.

The invention will now be described with respect to the following examples given by way of illustration and nonlimitingly.

### BRIEF DESCRIPTION OF THE DRAWINGS

FIG. 1 represents a graph illustrating the change in the viscosity Eta* (in Pa·s) at a shear stress frequency of 6.28 rad/s as a function of the temperature (in ° C.) of a composition such as illustrated in Example 1.

FIG. 2 represents a graph illustrating the change in the viscosity Eta* (in Pa·s) as a function of the shear stress frequency (in rad/s) at 80° C. and 100° C. for a composition such as illustrated in Example 1.

FIG. 3 represents a graph illustrating the change in the viscosity Eta* (in Pa·s) as a function of the shear stress frequency (in rad/s) at 20° C. and 30° C. for a composition such as illustrated in Example 1.

FIG. 4 represents a graph illustrating the change in the viscosity Eta* (in Pa·s) at a shear stress frequency of 6.28 rad/s as a function of the temperature (in ° C.) of a composition such as illustrated in Example 2.

FIG. 5 represents a graph illustrating the change in the viscosity Eta* (in Pa·s) as a function of the shear stress frequency (in rad/s) at 80° C. and 100° C. for a composition such as illustrated in Example 2.

FIG. 6 represents a graph illustrating the change in the viscosity Eta* (in Pa·s) as a function of the shear stress frequency (in rad/s) at 20° C. and 30° C. for a composition such as illustrated in Example 2.

FIG. 7 represents a graph illustrating the change in the viscosity Eta* (in Pa·s) at a shear stress frequency of 6.28 rad/s as a function of the temperature (in ° C.) of a composition such as illustrated in Example 3.

FIG. 8 represents a graph illustrating the change in the viscosity Eta* (in Pa·s) as a function of the shear stress frequency (in rad/s) at 90° C. and 110° C. for a composition such as illustrated in Example 3.

FIG. 9 represents a graph illustrating the change in the viscosity Eta* (in Pa·s) as a function of the shear stress frequency (in rad/s) at 20° C. and 30° C. for a composition such as illustrated in Example 3.

FIG. 10 represents a graph illustrating the change in the viscosity Eta* (in Pa·s) at a shear stress frequency of 6.28 rad/s as a function of the temperature (in ° C.) of two resins such as illustrated in Example 3.

FIG. 11 represents a graph illustrating the change in the viscosity Eta* (in Pa·s) as a function of the shear stress frequency (in rad/s) at 25° C. of two resins such as illustrated in Example 3.

FIG. 12 represents a graph illustrating the change in the viscosity Eta* (in Pa·s) as a function of the shear stress frequency (in rad/s) at 85° C. of two resins such as illustrated in Example 3.

### DETAILED SUMMARY OF PARTICULAR EMBODIMENTS

### Example 1

In this example, the copolymer used was an SBM triblock copolymer in which:
the S block was a homopolymer composed of the styrene monomer;
the B block was a homopolymer composed of the 1,4-butadiene monomer; and
the M block was a homopolymer composed of the methyl methacrylate monomer.

More precisely, this copolymer had the molecular characteristics:
content of S block: 55% of the total weight of the copolymer;
content of B block: 15% of the total weight of the copolymer;
content of M block: 30% of the total weight of the copolymer;
weight-average molecular weight M_{w} of the S block: 20150; and
weight % of the SB polymer relative to SBM: 36 wt % relative to the total weight of the copolymer.

This copolymer was present in the composition in an amount of 15 wt % relative to the total weight of the composition.

The composition tested comprises, in addition:
a bisphenol A diglycidyl ether resin (DER 332® sold by Dow); and
a 4,4′-methylenebis(2,6-diethylaniline) (MDEA) amine sold by Lonza under the trade name LONZACURE, the resin and the amine being present in an amount of 85 wt % of the total weight of the composition.

The protocol for producing the composition was the following:
the DER 332 resin from Dow was stirred at 160° C. in a vessel;
once the temperature had stabilized, the resin was degassed under vacuum;
after degassing, the vacuum was stopped and the SBM copolymer was introduced in powder form;
when all the SBM had dissolved in the epoxy resin, the mixture was degassed under vacuum;
after degassing, the temperature was lowered to 120° C., and the vacuum was stopped; and
the MDEA amine was introduced in a stoichiometric amount relative to the epoxy resin, namely with a ratio r=mass of amine/mass of resin=0.445.

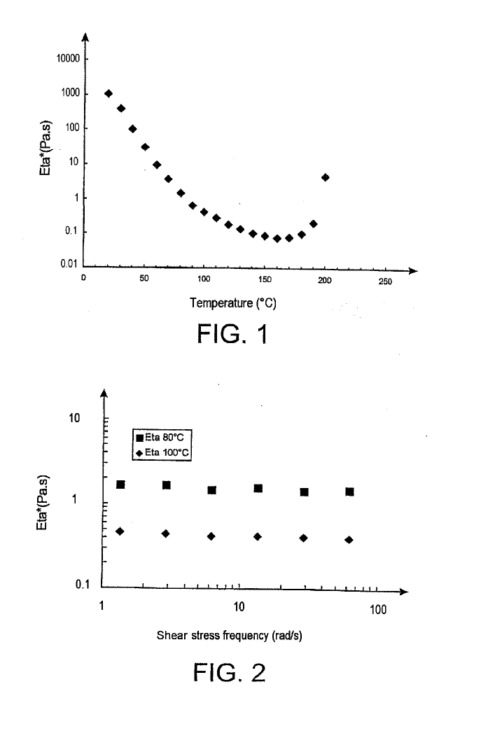

This composition was perfectly suitable to be used according to the filament winding process, as illustrated in FIG. 1, which shows the change in the viscosity of this composition as a function of the temperature.

Thus, the composition showed a viscosity of 1.5 Pa·s at 80° C. and of 0.4 Pa·s at 100° C. This viscosity range, in this temperature window, was perfectly suitable for coating a carbon or glass fiber according to the filament winding process.

Furthermore, in this temperature window, the mixture had a Newtonian character, that is to say that its viscosity did not vary with the strain rate of the mixture, as illustrated in FIG. 2.

This behavior constitutes a significant advantage as, at any traveling speed of the fiber into the bath of product, an equivalent coating will be produced.

Advantageously, this composition also shows a very large change in viscosity with temperature, contrary to the compositions of the prior art which retain a relatively low viscosity on exiting the bath.

It follows that, when the coated fiber exits the bath, run phenomena may occur, which will be the cause of change in the amount of product deposited on the fiber and also possible soiling on the various components of the process.

In the case of the composition of this example, these types of problems will not occur since the viscosity of the composition increases considerably when the temperature drops.

Very advantageously, the rheological behavior of the composition also changes when the temperature drops, having a pseudoplastic character at low temperature. The pseudoplastic character of the composition is expressed by a marked increase in the viscosity, when the shear rate decreases, which is the case for the fiber coated with the composition on exiting the bath, insofar as the shear rate is only due to the actual weight of the composition.

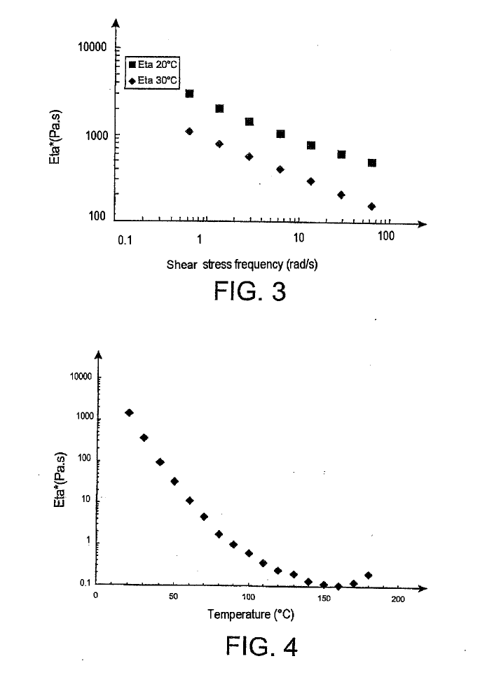

FIG. 3 shows this pseudoplastic character in the measurements at 20° C. and at 30° C.

Thus, at 20° C., the composition of this example has a viscosity of more than 1000 Pa·s at a shear stress frequency of 6.28 rad/s.

### Example 2

In this example, the copolymer used was an M-B-M copolymer in which:
the M blocks represent a copolymer comprising the methyl methacrylate monomer and the dimethylacrylamide monomer; and
the B block is a homopolymer composed of the n-butyl acrylate monomer.

More precisely, this copolymer comprised the following molecular characteristics:
content of n-butyl acrylate: 53 wt % of the total weight of the copolymer;
content of methyl methacrylate: 31%;
content of dimethylacrylamide: 16%;
number-average molecular weight Mₙ of the B block: 23780; and
polydispersity index PDI of the B block: 1.4.

This copolymer was present in the composition in an amount of 5 wt % relative to the total weight of the composition.

The composition used comprised, in addition:
an RTM6 epoxy resin from Hexcel; the resin being present in an amount of 95 wt % of the total weight of the composition.

The protocol for producing the composition was the following:
the RTM6 resin from Hexcel was stirred at 100° C. in a vessel;
once the temperature had stabilized, the resin was degassed under vacuum;
after degassing, the vacuum was stopped and the copolymer was introduced in powder form;
when all the copolymer had dissolved in the epoxy resin, the mixture was degassed under vacuum.

This composition was perfectly suitable to be used according to the filament winding process, as illustrated in FIG. 4, which shows the change in the viscosity of this composition as a function of the temperature.

Thus, the composition showed a viscosity of 1.8 Pa·s at 80° C. and of 0.6 Pa·s at 100° C. This viscosity range, in this temperature window, was perfectly suitable for coating a carbon or glass fiber according to the filament winding process.

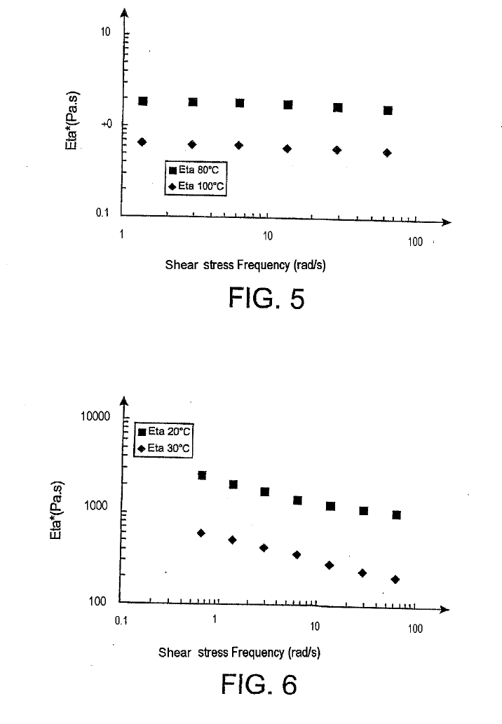

Furthermore, in this temperature window, the mixture had a Newtonian character, that is to say that its viscosity did not vary with the strain rate of the mixture, as illustrated in FIG. 5.

This behavior constitutes a significant advantage as, at any traveling speed of the fiber into the bath of product, an equivalent coating will be produced.

Very advantageously, this composition also shows a very large change in viscosity with temperature, contrary to the compositions of the prior art which retain a relatively low viscosity on exiting the bath.

It follows that, when the coated fiber exits the bath, run phenomena may occur, which will be the cause of change in the amount of product deposited on the fiber and also possible soiling on the various components of the process.

In the case of the composition of this example, these types of problems will not occur since the viscosity of the composition increases considerably when the temperature drops and when the rheological behavior of the composition changes, having a pseudoplastic character at low temperature.

The pseudoplastic character of the composition is expressed by a marked increase in the viscosity, when the shear rate decreases, which is precisely the case for the fiber coated with the composition on exiting the bath, insofar as the shear rate is only due to the actual weight of the composition.

FIG. 6 shows this pseudoplastic character in the measurements at 20° C. and at 30° C.

At 20° C., the composition of this example has a viscosity of more than 1000 Pa·s at a shear stress frequency of 6.28 rad/s.

### Example 3

In this example, the copolymer used was an M-B-M copolymer in which:
the M blocks represent a polymer comprising the methyl methacrylate monomer; and
the B block is a homopolymer composed of the n-butyl acrylate monomer.

More precisely, this copolymer comprised the following molecular characteristics:
content of n-butyl acrylate: 42 wt % of the total weight of the copolymer;
content of methyl methacrylate: 58%;
number-average molecular weight Mₙ of the B block: 21200; and
polydispersity index PDI of the B block: 1.3.

This copolymer was present in the composition in an amount of 10 wt % relative to the total weight of the composition.

The composition used comprised, in addition:
an RTM6 epoxy resin from Hexcel; the resin being present in an amount of 90 wt % of the total weight of the composition.

The protocol for producing the composition was the following:
the RTM6 resin from Hexcel was stirred at 100° C. in a vessel;
once the temperature had stabilized, the resin was degassed under vacuum;
after degassing, the vacuum was stopped and the copolymer was introduced in powder form;
when all the copolymer had dissolved in the epoxy resin, the mixture was degassed under vacuum.

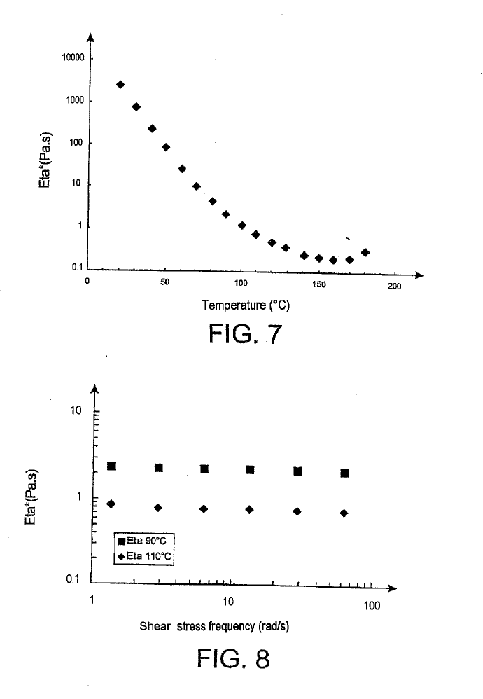

This composition was perfectly suitable to be used according to the filament winding process, as illustrated in FIG. 7, which shows the change in the viscosity of this composition as a function of the temperature.

Thus, the composition showed a viscosity of 2.3 Pa·s at 90° C. and of 0.8 Pa·s at 110° C. This viscosity range, in this temperature window, was perfectly suitable for coating a carbon or glass fiber according to the filament winding process.

Furthermore, in this temperature window, the mixture had a Newtonian character, that is to say that its viscosity did not vary with the strain rate of the mixture, as illustrated in FIG. 8.

This behavior constitutes a significant advantage as, at any traveling speed of the fiber into the bath of product, an equivalent coating will be produced.

Very advantageously, this composition also shows a very large change in viscosity with temperature, contrary to the compositions of the prior art which retain a relatively low viscosity on exiting the bath.

It follows that, when the coated fiber exits the bath, run phenomena may occur, which will be the cause of change in the amount of product deposited on the fiber and also possible soiling on the various components of the process.

In the case of the composition of this example, these types of problems will not occur since the viscosity of the composition increases considerably when the temperature drops and when the rheological behavior of the composition changes, having a pseudoplastic character at low temperature. The pseudoplastic character of the composition is expressed by a marked increase in the viscosity, when the shear rate decreases, which is the case for the fiber coated with the composition on exiting the bath, insofar as the shear rate is only due to the actual weight of the composition.

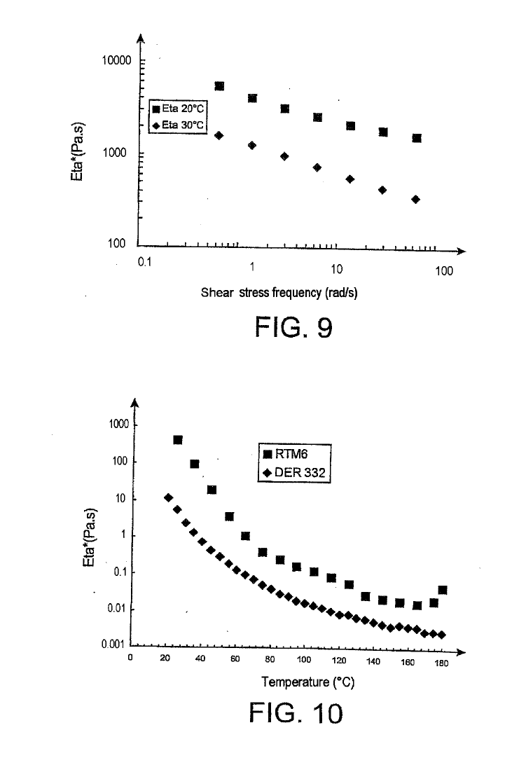

FIG. 9 shows this pseudoplastic character in the measurements at 20° C. and at 30° C.

At 30° C., the composition of this example has a viscosity of more than 1000 Pa·s at a shear stress frequency of 6.28 rad/s.

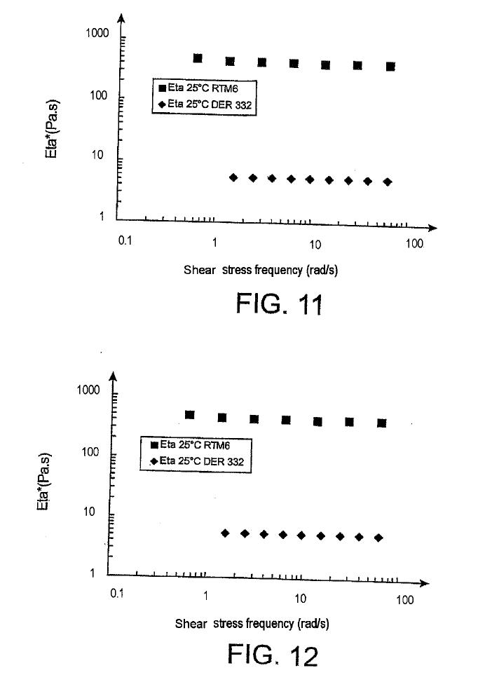

FIG. 10 shows the change in the viscosity as a function of the temperature for the DER 332 resin and also for the RTM6 resin. FIG. 11 shows the viscosities at 25° C. and FIG. 12 at 85° C. for the two resins. They are outside the range that is most suitable for a filament winding process and have a Newtonian behavior, even at low temperature. The table below illustrates the viscosity values at 25° C. and at 85° C. for these two resins.

| Eta (Pa · s) | 25° C. | 85° C. |
|---|---|---|
| DER 332 | 5.6 | 0.03 |
| RTM6 | 420 | 0.3 |

1. A process for producing composite materials comprising the step of filament winding, said process comprises the use of a composition comprising:
at least one resin formulation comprising at least one thermosetting resin;
at least one rheology control agent that is miscible in said formulation such that:
wherein said composition exhibits at least a 100-fold difference in viscosity between a high-temperature state at shear rate C₁ and a low-temperature state at shear rate C₂, the temperature difference between the high-temperature state and the low-temperature state being at least 30° C. and the shear rate C₁ being greater than the shear rate C₂; and
wherein the composition has a Newtonian behavior at the high-temperature state.

2. The process as claimed in claim 1, wherein the temperature difference between the high-temperature state and the low-temperature state is at least 60° C.

3. The process as claimed in claim 1, wherein the viscosity difference is at least 500-fold.

4. The process as claimed in claim 1, wherein the rheology control agent comprises a block copolymer, of which at least one of the blocks is incompatible with said resin formulation.

5. The process as claimed in claim 4
wherein said
rheology control agent block copolymer comprises:
at least one M block miscible with said resin formulation; and
at least one B block incompatible with said resin formulation and said M block.

6. The process as claimed in claim 5, wherein M is a methyl methacrylate homopolymer or a methyl methacrylate copolymer.

7. The process as claimed in claim 6, wherein M is a copolymer comprising methyl methacrylate and at least one water-soluble monomer.

8. The process as claimed in claim 7, wherein, in M, the molar proportion of methyl methacrylate is 10 to 95% per 90 to 5% of water-soluble monomer.

9. The process as claimed in claim 8, wherein the molar proportion of methyl methacrylate is 60 to 90% per 40 to 10% of water-soluble monomer.

10. The process as claimed in claim 7, wherein the water-soluble monomer is dimethylacrylamide.

11. The process as claimed in claim 5, wherein the B block is selected from the group consisting of poly(alkyl(meth)acrylate)s and polydienes.

12. The process as claimed in claim 5, wherein the B block comprises poly(n-butyl acrylate).

13. The process as claimed in claim 5, wherein the rheology control agent is an M-B-M triblock copolymer.

14. The process as claimed in claim 13, wherein the copolymer is an M-B-M copolymer in which:
the M blocks represent a copolymer comprising methyl methacrylate monomer units and; and
the B block is a homopolymer composed of n-butyl acrylate monomer units,
the M blocks optionally comprising n-butyl acrylate monomer.

15. The process as claimed in claim 14, wherein the copolymer is an M-B-M copolymer wherein:
the M blocks represent a polymer comprising the methyl methacrylate monomer and dimethylacrylamide monomer units; and
the B block is a homopolymer composed of the n-butyl acrylate monomer, the M blocks possibly also comprising the n-butyl acrylate monomer.

16. The process as claimed in claim 5, wherein the block copolymer further comprises, an S block incompatible with said resin formulation and the B block and wherein the S block is a polystyrene.

17. (canceled)

18. The process as claimed in claim 16, wherein the copolymer is an S-B-M copolymer comprising:
an S block consisting of an homopolymer composed of the styrene monomer;
a B block consisting of a homopolymer composed of the 1,4-butadiene monomer; and
an M block consisting of a homopolymer composed of the methyl methacrylate monomer.

19. (canceled)

20. (canceled)

21. The process as claimed in claim 1, wherein the thermosetting resin is an epoxy resin.

22. The process as claimed in claim 21, wherein the epoxy resin is chosen from resorcinol diglycidyl ether, bisphenol A diglycidyl ether, triglycidyl p-aminophenol, bromobisphenol F diglycidyl ether, m-aminophenol triglycidyl ether, tetraglycidyl methylene dianiline, (trihydroxy-phenyl)methane triglycidyl ether, phenol-formaldehyde novolac polyglycidyl ethers, ortho-cresol novolac polyglycidyl ethers and tetraphenylethane tetraglycidyl ethers.

23. The process as claimed in claim 1, wherein the resin formulation comprises a curing agent.

24. The process as claimed in claim 23, wherein the curing agent is chosen from acid anhydrides, aromatic or aliphatic polyamines, dicyandiamide, imidazoles, polycarboxylic acids, polyphenols.

25. The process of claim 1 comprising the successive steps of:
passing fibers intended to form the reinforcement of the part into a bath that consists of the composition of claim 1;
winding the fibers thus coated onto a mandrel of suitable shape;
curing the wound fibers.

26. (canceled)

27. (canceled)

28. The process as claimed in claim 25, in which the fibers are chosen from glass fibers, carbon fibers, aramid fibers and mixtures of these fibers.

29. (canceled)

30. The process as claimed in claim 1, wherein said composite material comprises a part for the aeronautics industry or a hose for the transport of fluids.

31. (canceled)

32-34. (canceled)
